(19) United States
(12) Patent Application Publication
(10) Pub. No.: US 2009/0164436 A1
(43) Pub. Date: Jun. 25, 2009

(54) MEDICAL IMAGE INFORMATION MANAGEMENT SYSTEM AND PROGRAM PRODUCT

(76) Inventors: Yang Du, Beijing (CN); Haifeng Bian, Beijing (CN)

Correspondence Address: Patrick W. Rasche;Armstrong Teasdale LLP, Suite 2600, One Metropolitan Square, St. Louis, MO, 63102, US

(21) Appl. No.: 12/337,464

(22) Filed: Dec. 17, 2008

(30) Foreign Application Priority Data
Dec. 21, 2007 (CN) 200710160052.5

(51) Int. Cl. G06F 17/30

(52) U.S. Cl. 707/3; 707/E17.014

(57) ABSTRACT

The present invention provides a medical image information management system and a program product which allow generating a list containing the information on the medical images such as a work list, with a better workability. The medical image information management system for managing the information on the medical images includes a search device for searching the information regarding medical image using a desired query, a query storing device for storing the query established by the user, and a list generating device for generating a list containing the information on the medical images extracted as the result of search based on the query established by the user and storing in a folder.

### CROSS REFERENCE TO RELATED APPLICATIONS

This application claims the benefit of Chinese Patent Application No. 200710160052.5 filed Dec. 21, 2007, which is hereby incorporated by reference in its entirety.

### BACKGROUND OF THE INVENTION

The subject matter disclosed herein relates to a medical image information management system for managing information regarding medical image such as requesting information of medical image processing service, and a program product used therefor.

In a RIS (radiology information system) or a PACS (picture archiving and communication system), a medical worker requests to a server a medical image service via a user terminal in order to executing a predetermined service such as diagnosis and creation of a report by browsing the medical images displayed (see, for example, Japanese Unexamined Patent Publication No. 2005-327302).

### BRIEF DESCRIPTION OF THE INVENTION

A work list is used for requesting a medical image service. The work list is a list containing the work items, more specifically an image service request. The work list may be generated by inputting the search information into the query criteria displayed on a user terminal.

From the view of versatility, the query criteria are organized so as to be exhaustive, and is arranged so as not to correspond to individual circumstances of the user. For this reason the generating of a work list based on the query criteria therefore does not have an excellent workability.

A medical image information management system is provided, which allows generating a list containing the information regarding medical image such as a work list with a better workability, and a program product used therefore. Also, a medical image information management system is provided, which allows generating the list containing the information regarding the medical image such as a work list, with a better handleability, and a program product used therefore.

A first aspect provides a medical image information management system for managing information regarding medical images, comprising: a search device, for searching the information regarding medical image using a desired query; a query storing device for storing a query set by a user; and a list generating device for generating a list of information regarding medical image extracted as the result of searching based on the query set by the user and storing it in a folder.

A second aspect provides a medical image information management system in accordance with the first aspect described above, further comprising: a number-of-items display device for displaying the number of items of the information regarding medical image included in the list stored in the folder.

A third aspect provides a medical image information management system in accordance with the first aspect described above, further comprising: a list display device, operable by the selection of a control button, for displaying the list of the information regarding medical image stored in the folder.

A fourth aspect provides a medical image information management system in accordance with the first aspect described above, further comprising: a waiting list generating device, for storing a list of the information regarding the medical images newly created or updated, which is extracted as the result of searching based on the query set by the user.

A fifth aspect provides a medical image information management system in accordance with the fourth aspect described above, wherein the list generating device updates in the folder the information regarding medical image stored in the waiting list generating device by the selection of a control button.

A sixth aspect provides a medical image information management system in accordance with the fifth aspect described above, further comprising: a number display device for displaying the number of updated items of the information regarding medical image stored in the folder.

A seventh aspect provides a medical image information management system in accordance with the first aspect described above, further comprising: a server computer; and a communication device for communicating the information regarding medical image with the server computer.

An eighth aspect provides a medical image information management system in accordance with the seventh aspect described above, wherein the information regarding the medical images is the information requesting image processing service to the server.

A ninth aspect provides a medical image information management system in accordance with the seventh aspect described above, wherein the medical image information management system is a RIS or a PACS system.

A tenth aspect, provides a computer program product, for generating a list containing information regarding the medical images by using a computer, comprising: a program code for storing in a memory medium of a computer a query for searching information regarding medical image established by a user; and a program code, operable by the selection of a control button for reading out a query established by the user, for performing a search for the information regarding medical image based on the query, generating a list containing the information regarding medical image extracted as the result of the search, and storing it in a folder.

An eleventh aspect provides a program product in accordance with the tenth aspect described above, further comprising: a program code for counting the number of items of the information regarding medical image included in the list stored in the folder.

A twelfth aspect provides a program product in accordance with the tenth aspect described above, further comprising: a program code operable by the selection of the control button for displaying a list containing the information regarding medical image extracted as the result of the search.

A thirteenth aspect provides a program product in accordance with the tenth aspect described above, further comprising: a program code for reading the information regarding the medical images newly created or updated, reading a query set by the user, and executing the search for the information regarding medical image based on the query.

A fourteenth aspect provides a program product in accordance with the thirteenth aspect described above, further comprising: a program code, operable by the selection of the control button, for updating in a folder the information regarding medical image extracted as the result of the search.

A fifteenth aspect provides a program product in accordance with the fourteenth aspect described above, further comprising: a program code for counting the number of items updated on the list of the information regarding medical images stored in the folder.

A sixteenth aspect provides a program product in accordance with the tenth aspect described above, further comprising: a program code for selecting the information regarding medical image from the list in the folder in order to send it to a server computer.

A seventeenth aspect provides a program product in accordance with the sixteenth aspect described above, wherein the information regarding medical image is the information requesting an image processing service to a server.

An eighteenth aspect provides a program product in accordance with the tenth aspect described above, wherein the program product is used in a client computer within a RIS or a PACS system.

In accordance with the medical image information management system and the program product of the, a list may be generated based on a query which can be set by the user, which has a better workability and handleability.

### BRIEF DESCRIPTION OF THE DRAWINGS

FIG. 1 is a schematic diagram illustrating an exemplary RIS;

FIG. 2 is a schematic diagram illustrating the arrangement of a terminal device;

FIG. 3 is a gray-scale photograph illustrating an exemplary user interface;

FIG. 4 is a flow chart for generating a work list;

FIG. 5 is a gray-scale photograph illustrating an exemplary user interface;

FIG. 6 is a gray-scale photograph illustrating an exemplary user interface; and

FIG. 7 is a flow chart for updating a work list.

### DETAILED DESCRIPTION OF THE INVENTION

Various embodiments of the invention will be described in greater details herein below with reference to the accompanying drawings. It should be noted here that the present invention is not to be considered to be limited by the embodiments described herein.

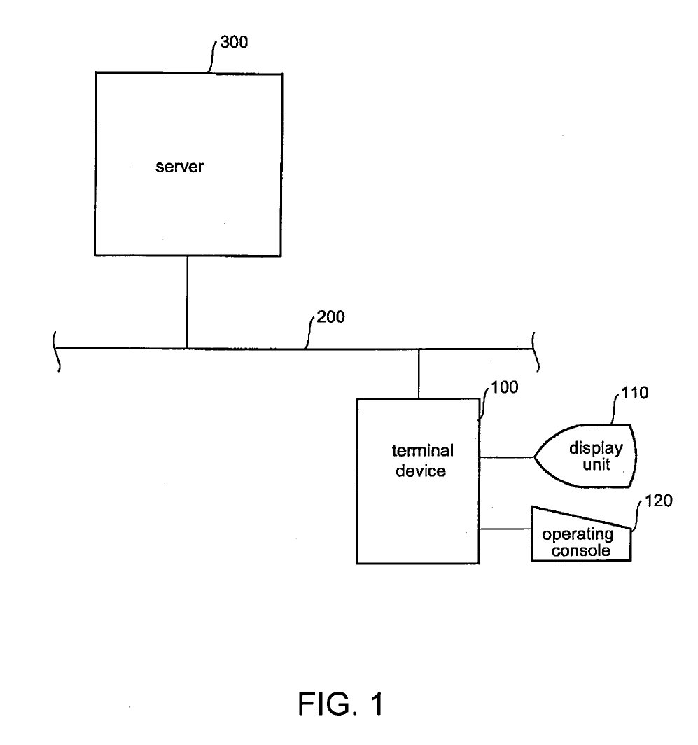

Now referring to FIG. 1 there is shown a schematic diagram of a RIS (radiology information system). The present system is one embodiment of such a RIS. As such, the arrangement of the present system indicates only one example with respect to the medical image information management system and the program product described herein.

As shown in FIG. 1, the system has a terminal device 100. The terminal device 100 has a display unit 110 and an operating console 120. The display unit 110 may be formed by for example a graphic display or the like. The operating console 120 may be formed by for example a keyboard. The operating console 120 includes a pointing device, which allows operating the user interface displayed on the display unit 110.

The terminal device 100 is connected to a network 200. On the network 200 there may be a number of other terminals, however in the figure one terminal represents these other terminals. On the network 200 there is a server 300. The server 300 provides a medical image service to the terminal device 100. The medical images may be taken by means of one of a plurality of medical image apparatuses including such as an MRI apparatus, an X-ray CT apparatus, an X-ray imaging apparatus, an ultrasound diagnostic device.

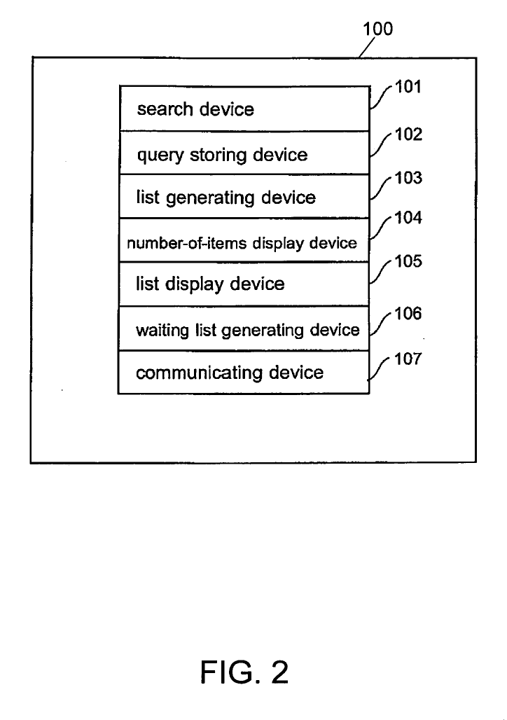

As shown in FIG. 2, the terminal device 100 includes a search device 101 for searching for the information regarding the medical images by means of a desired query, a query storing device 102 for storing the query established by the user, a list generating device 103 for generating a list containing the information regarding medical image extracted as the result of search based on the query set by the user and storing it in a folder.

It is preferable for the terminal to have a number-of-items display device 104 for displaying the number of items of the information regarding the medical images stored in the folder, and a list display device 105 for displaying the information regarding the medical images stored in a folder, which is operable by the selection of a control button. In addition, it is preferable to have a waiting list generating device 106 for storing the list containing the information regarding the medical images extracted as the result of the search based on a query set by the user on the information regarding medical image newly created or updated. Terminal device 100 also includes a communicating device 107 that communicates with server 300 via network 200.

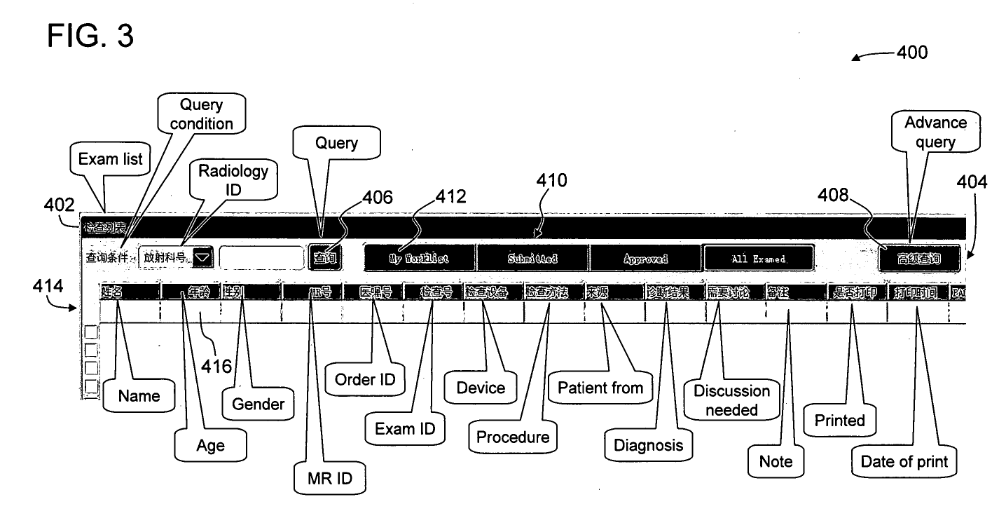

The operation of the system will be described by the description of the method of generating a work list. Now referring to FIG. 3 there is shown an example of the user interface 400 for generating a work list. The user interface 400 is displayed on the display unit 110. As shown in FIG. 3 the user interface 400 contains at the first line a title line 402, at the second line an interactive line 404. The interactive line 404 is the line interactively operable by the user with a pointing device.

The interactive line 404 has a search button 406 at second leftmost, and an advanced search button 408 at the rightmost. The interactive line 404 also has four folders 410 between these two buttons 406 and 408. These four folders 410 will be referred to as search folder herein below. The leftmost of these four search folders is a search folder 412 used for the work list.

The fourth line of the user interface contains query criteria 414. The query criteria 414 is the region into which the search query or conditions are input, and input items 416 and input cells including the name, age, sex and so on are arranged in the horizontal direction.

The input items 416 in the query criteria 414 are customizable by the user. The customization of the input items 416 may be done in the advanced search mode.

The user switches to the advanced search mode by clicking the advanced search button 408. In this mode, the titles of the input items 416 in the query criteria 414 may be rewritten as required. More specifically, for example, user is allowed removing an unnecessary item and adding a new item. By doing this the user may customize the query criteria 414 so as to suit to his/her desire.

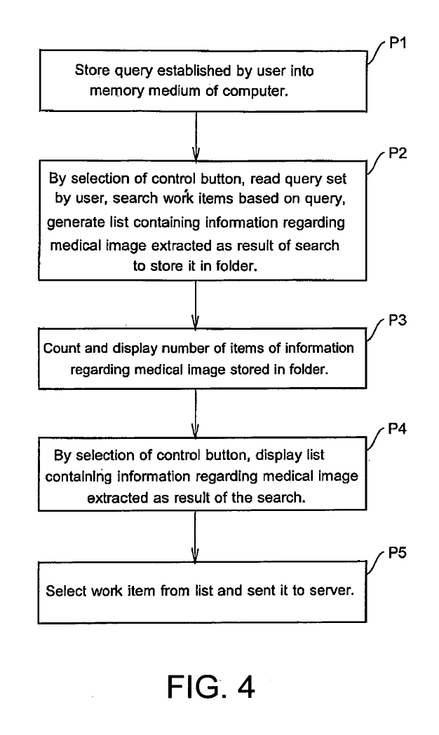

The query established in this mode is stored in a memory medium of a computer with a title (see FIG. 4 P1). When the search button is clicked while the query is read, the server 300 starts searching, and the search result will be displayed on the terminal device 100 (see FIG. 4 P2).

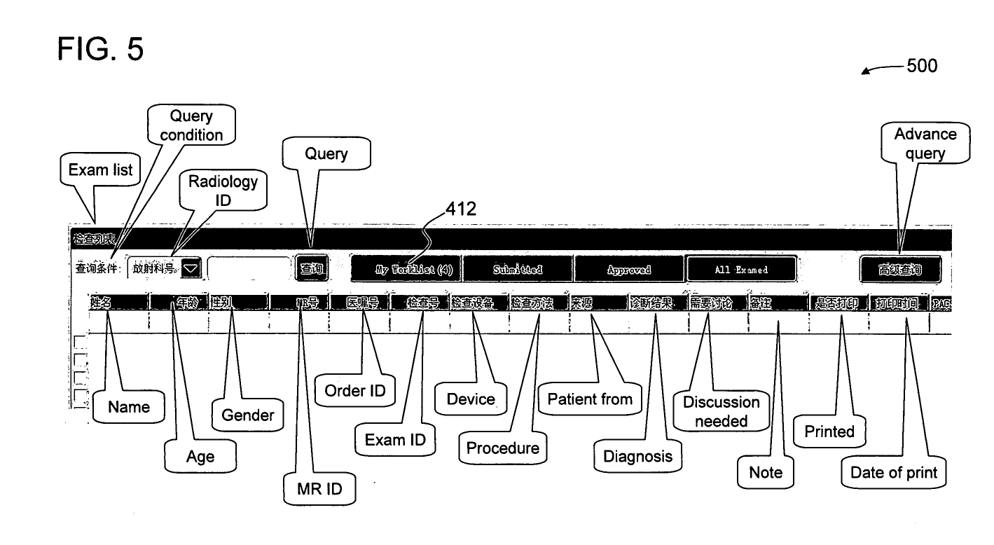

Now referring to FIG. 5 there is shown an example of search result display 600. As shown in FIG. 5, the number of work items hit (4 in this case) is displayed (see FIG. 4 P3) on the search folder 412 for the work list. From the display, the user may recognize that there are four work items which match with the query criteria 414.

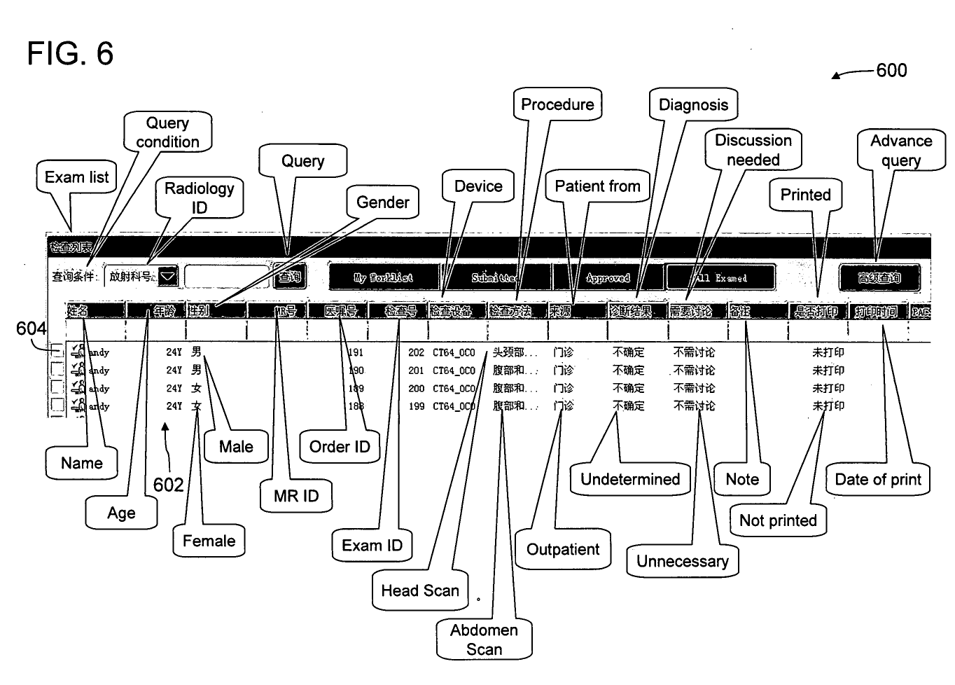

When details of one of work items are wanted, the user will click the search folder 412 for the work list. By doing this, as shown in FIG. 6, the contents 602 of four work items will be displayed beneath the query criteria 414 (see FIG. 4 P4).

The aggregation of work items constitutes a work list. As a work list may be formed based on the query criteria customized by the user, it is arranged with better workability. In addition, since the work list is formed as a folder format for each user, it has a better handleability.

In correspondence with each work item, there are check boxes 604 at the left side thereof. By checking in a check box 604, the work item checked will be performed. In other words, an image service request is sent from the terminal device 100 to the server 300, in reply the server 300 performs the medical image service for the terminal device 100 (see FIG. 4 P5). The user will make use of the medical image displayed on the terminal device 100 to perform a predetermined work such as to conduct a diagnosis or to create a report.

The work list reflects always the newest situation. To enable this, the work list is updated in correspondence with the change in the examination information. The update of the work list is automated.

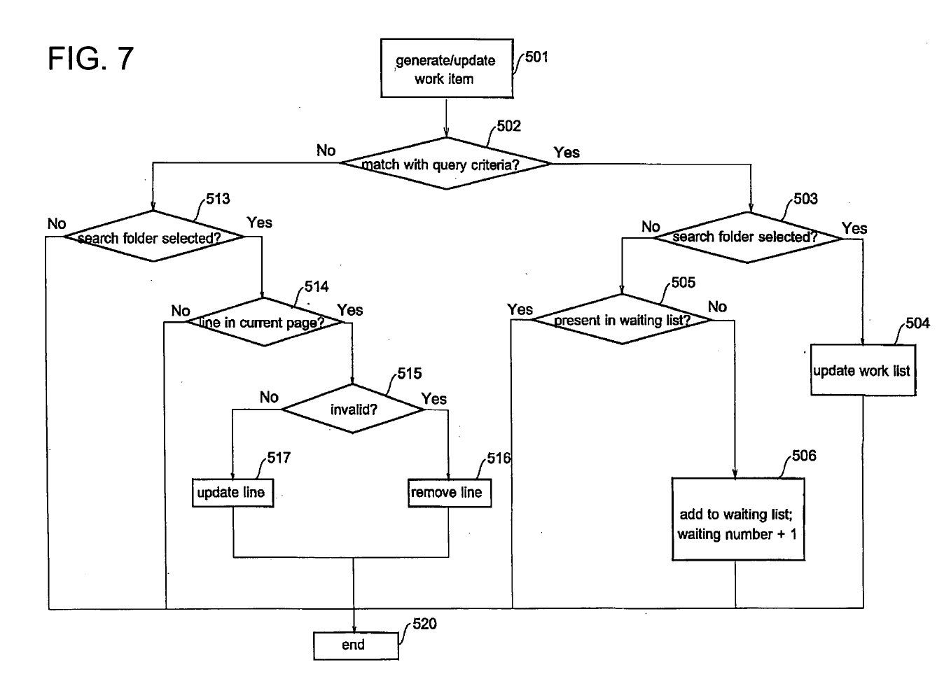

Now referring to FIG. 7 there is shown a flow chart describing how to update a work list. As shown in FIG. 7, in step 501, a work item is created or updated, in step 502; the examination thereof will determine whether or not to comply with the query criteria.

When matched with the query criteria, in step 503, a search folder is determined whether or not to be selected, and if selected, in step 504, a work list is updated.

If the search folder is not selected then in step 505 the list is determined whether or not to be listed already in the waiting list. If it is in the waiting list then nothing is performed, while if it is not in the waiting list then it is added to the waiting list, in step 506.

At this time the waiting number is added with 1. The waiting number is displayed on the search folder, as shown in FIG. 5. The contents of the waiting list may be displayed by clicking on the search folder.

In step 502, if it is determined that the examination is not matched with the query criteria, then in step 513, the search folder is determined whether or not to be selected. If the search folder is not selected then nothing is performed, whereas if the folder is selected then selected one is determined whether or not to be the line in the current page, in step 514.

If it is not the line in the current page then nothing is performed. However, if it is the line in the current page then in step 515 it is determined if it is invalid or not, and if it is invalid then the line is removed in step 516, or if it is not invalid then the line is updated in step 517.

After the foregoing processing, the process will terminate in step 520.

1. A medical image information management system configured to manage medical image information, said medical image information management system comprising
a search device configured to search the medical image information using a desired query;
a query storing device configured to store a query set by a user; and
a list generating device configured to generate a list of the medical image information extracted as the result of a search by said search device based on the query set by the user, said list generating device further configured to store the list in a folder.

2. A medical image information management system according to claim 1, further comprising:
a number-of-items display device configured to display a number of items of the medical image information included in the list which is stored in the folder.

3. A medical image information management system according to claim 1, further comprising:
a list display device configured to display the list of medical image information stored in the folder, said list display device further configured to be operable by a selection of a control button.

4. A medical image information management system according to claim 1, further comprising:
a waiting list generating device configured to store a list of the medical image information newly created or updated, which is extracted as the result of searching based on the query set by the user.

5. A medical image information management system according to claim 4, wherein:
said list generating device in is configured to update the folder with the medical image information stored in said waiting list generating device by the selection of a control button.

6. A medical image information management system according to claim 5, further comprising:
a number display device configured to display a number of updated items of the medical image information image stored in the folder.

7. A medical image information management system according to claim 1, further comprising:
a server computer; and
a communication device configured to communicate the medical image information with said server computer.

8. A medical image information management system according to claim 7, wherein:
the medical image information is the information requesting image processing service to said server computer.

9. A medical image information management system according to claim 7, wherein:
said medical image information management system is one of a RIS system and a PACS system.

10. A computer program product for generating a list containing medical image information using a computer coupled to a server via a network, said computer program product comprising:
a program code for storing, in a memory medium of the computer, a query for searching medical image information set by a user; and
a program code operable by a selection of a control button within an interface of the computer for reading out a query set by the user, for performing a search for the medical image information based on the query, generating a list containing the medical image information extracted from the server as the result of the search, and storing the extracted medical image information in a folder displayable to the user at the computer.

11. A program product according to claim 10, further comprising:
a program code for counting a number of items of the medical image information stored in the folder.

12. A program product according to claim 10, further comprising:
a program code operable by the selection of the control button for displaying a list containing the medical image information extracted from the server as the result of the search.

13. A program product according to claim 10, further comprising:
a program code for reading medical image information newly created or updated, for reading the query set by the user, and for executing the search for the medical image information regarding medical image based on the query.

14. A program product according to claim 13, further comprising:
a program code, operable by the selection of the control button, for updating in the folder the medical image information extracted from the server as the result of the search.

15. A program product according to claim 14, further comprising:
a program code for counting a number of items updated on the medical image information stored in the folder for displaying to the user at the computer.

16. A program product according to claim 10, further comprising:
a program code for selecting the medical image information from the list in the folder in order to send it to the server.

17. A program product according to claim 16, wherein:
the medical image information is the information requesting an image processing service to the server.

18. A program product according to claim 10, wherein:
the program product is used in a client computer within one of a RIS system and a PACS system.

19. A method for managing medical image information using a computer coupled to a server over a network, said method comprising:
searching the medical image information using a desired query;
storing the query set by a user;
extracting from the server a list of medical image information based on the query set by the user; and
generating the list of the extracted medical image information and storing the list in a folder displayable to the user at the computer.

20. A method according to claim 19, further comprising displaying to the user via a user interface a number of items of the medical image information included in the list stored in the folder.
